(19) United States
(12) Patent Application Publication
(10) Pub. No.: US 2014/0029425 A1
(43) Pub. Date: Jan. 30, 2014

(54) Method And Apparatus For Inter-Carrier Load Balancing

(71) Applicants: Kiran M. Rege, Marlboro, NJ (US); Krishna Balachandran, Morganville, NJ (US); Joseph H. Kang, Belle Mead, NJ (US); Kemal M. Karakayali, Hoboken, NJ (US)

(72) Inventors: Kiran M. Rege, Marlboro, NJ (US); Krishna Balachandran, Morganville, NJ (US); Joseph H. Kang, Belle Mead, NJ (US); Kemal M. Karakayali, Hoboken, NJ (US)

(21) Appl. No.: 13/559,237

(22) Filed: Jul. 26, 2012

(51) Int. Cl. H04W 28/02

(52) U.S. Cl. CPC H04W 28/0215
USPC 370/235

(57) ABSTRACT

Various methods and devices are provided to address the need for improved inter-carrier load balancing. In one method, network equipment determines (101) an achievable rate for a plurality of wireless devices on each carrier of a plurality of carriers. Inter-carrier load balancing is performed (102) by the network equipment by assigning a carrier of the plurality of carriers to each wireless device using the determined achievable rate of that wireless device on each carrier.

### FIELD OF THE INVENTION

The present invention relates generally to communications and, in particular, to inter-carrier load balancing in wireless communication systems.

### BACKGROUND OF THE INVENTION

This section introduces aspects that may help facilitate a better understanding of the inventions. Accordingly, the statements of this section are to be read in this light and are not to be understood as admissions about what is prior art or what is not prior art.

In a cellular network, a user (wireless device) is typically served by the base station to which it has the strongest signal. If a base station communicates over multiple carriers (e.g., two 10 MHz carriers for LTE (Long Term Evolution)), it would typically transmit at similar powers on each carrier and a given user would perceive comparable averaged signal strengths on each of these carriers. Hence, a typical inter-carrier load balancing algorithm would balance the number of users on each carrier using methods such as hashing. Alternatively, a typical load balancing algorithm may attempt to equalize the expected traffic carried on each carrier, where users may have different traffic demands.

Recently, there has been great interest in overlaying metro cells with macro cells, both using the same spectrum. Because macro cells transmit at much higher powers, the coverage area for metro cells is very small. Cell selection bias can increase the serving area of metro cells, but bias values must be kept small in order to maintain control channel performance. Almost Blanked Subframes (ABS) will be introduced in LTE Rel 10, but simulations have shown that bias values will still be limited because interference from Cell-Specific Reference Signals (CRS) remains and can be significant at high bias values. Hence, relatively few users are served by metro cells and associated gains may be modest.

We have proposed an alternative solution called Soft Reuse which employs power management. Soft reuse is attractive because it is available to legacy UEs (and thus could yield immediate benefits), allows high biases, and yields comparable or even higher gains than ABS-based techniques, depending on the scenario. With soft reuse, transmission powers from a given base station (macro or metro) may be vastly different over each carrier. The typical inter-carrier load balancing algorithm that attempts to equalize the number of users on each carrier and/or the expected traffic on each carrier will likely provide a sub-optimal end user experience in a Soft Reuse environment. Thus, new approaches and techniques that are able to improve inter-carrier load balancing would meet a need and advance wireless communications generally.

### BRIEF DESCRIPTION OF THE DRAWINGS

FIG. 1 is a logic flow diagram of functionality performed by a network equipment in accordance with various embodiments of the present invention.

FIG. 2 is a logic flow diagram of functionality performed by a network equipment in accordance with certain embodiments of the present invention.

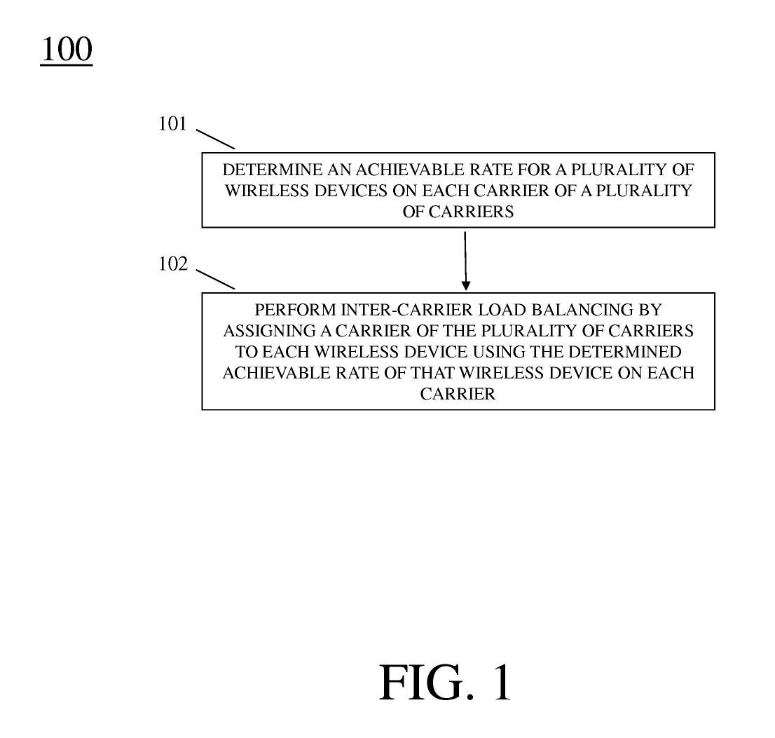

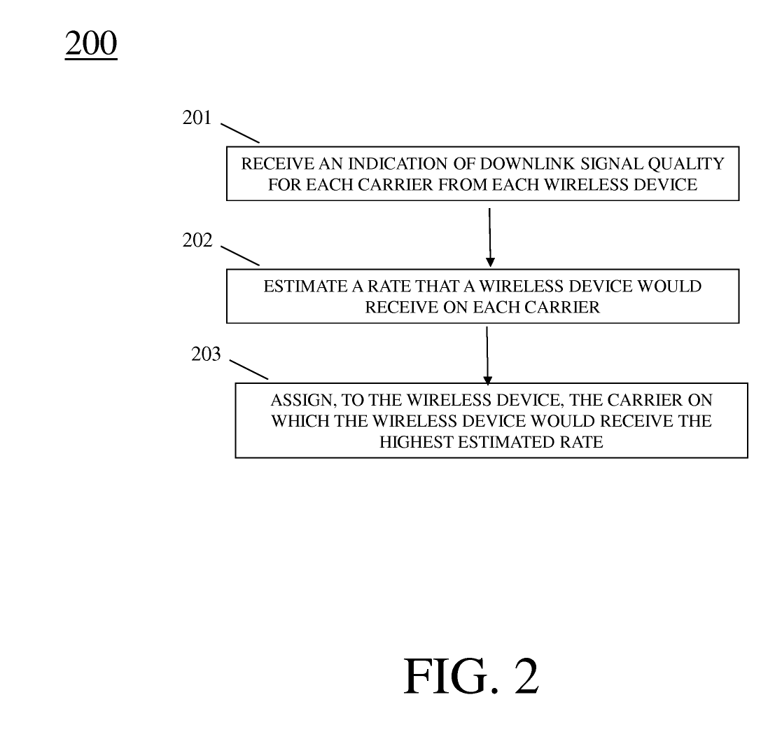

Specific embodiments of the present invention are disclosed below with reference to FIGS. 1 and 2. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the logic flow diagrams above are described and shown with reference to specific steps performed in a specific order, some of these steps may be omitted or some of these steps may be combined, sub-divided, or reordered without departing from the scope of the claims. Thus, unless specifically indicated, the order and grouping of steps is not a limitation of other embodiments that may lie within the scope of the claims.

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### DETAILED DESCRIPTION OF EMBODIMENTS

Various methods and devices are provided to address the need for improved inter-carrier load balancing. In one method, depicted in logic flow 100 of FIG. 1, network equipment determines (101) an achievable rate for a plurality of wireless devices on each carrier of a plurality of carriers. Inter-carrier load balancing is performed (102) by the network equipment by assigning a carrier of the plurality of carriers to each wireless device using the determined achievable rate of that wireless device on each carrier.

Many embodiments are provided in which the method above is modified. For example, in many embodiments, such as depicted in logic flow 200 of FIG. 2, the network equipment determines the channel quality for the plurality of wireless devices on each carrier by receiving (201) an indication of downlink signal quality for each carrier from each wireless device. In embodiments in which the network equipment is implemented as a base station, the base station may receive such signal quality reports from the wireless devices directly, for example. In some embodiments, the network equipment performs inter-carrier load balancing by estimating (202) a rate that a wireless device would achieve on each carrier of the plurality of carriers and then assigning (203), to the wireless device, the carrier on which the wireless device would achieve the highest estimated rate.

Depending on the embodiment, the network equipment may also determine that a wireless device is a member of a restricted class, based on a certain characteristic (such as a level of mobility or what applications are being used on the wireless device, e.g.). The network equipment may then assign a carrier to the wireless device, as required by the restricted class, before performing inter-carrier load balancing for the other wireless devices needing carrier assignments.

Various network equipment architectures may be used to implement inter-carrier load balancing, depending on the embodiment. For example, the network equipment may include a single device or multiple devices, such as one or more base stations and/or other network devices, the devices acting either individually to perform certain functionality or in a distributed manner (such as in a cloud computing architecture).

To provide a greater degree of detail in making and using various aspects of the present invention, a description of our approach to inter-carrier load balancing and a description of certain, quite specific, embodiments follows for the sake of example. Our approach to inter-carrier load balancing attempts to address a unique problem that is introduced with soft reuse. Mainly, with soft reuse, transmission powers from a given base station (macro or metro) may be vastly different over each carrier. As a result, the downlink signal-to-interference-plus-noise ratios (SINR) that a wireless device or UE (user equipment) perceives on each carrier of a given serving cell may be quite different. Consequently, in order to achieve a more optimal end user experience, the load balancing method employed by the cell needs to take into account the channel quality experienced by users on different carriers associated with that cell. Intra-cell load balancing algorithms that factor in the number of users or the sum traffic, but do not account for user channel quality, are likely to exhibit distinctly inferior performance in heterogeneous networks employing soft reuse.

In several embodiments of the present invention, intra-cell, inter-carrier load balancing is performed in a manner that considers user channel quality, resource availability, and the number of users. Without loss of generality, consider a base station with two carriers, f1 and f2. In 3GPP LTE, a carrier may take on different bandwidths ranging from 1.4 MHz to 20 MHz. Let the bandwidth of f1 and f2 be W1 and W2, respectively. Further, assume that N users are served by this base station and their channel quality (signal-to-noise+interference ratio, SINR, for example) on f1 and f2 is Qᵢ⁽¹⁾ and Qᵢ⁽²⁾, respectively, for i=1, 2, . . . , N.

The channel quality, Qᵢ⁽¹⁾ and Qᵢ⁽²⁾, is converted to a spectral efficiency for all users, where Sᵢ⁽¹⁾=f(Qᵢ⁽¹⁾) and Sᵢ⁽²⁾=f(Qᵢ⁽²⁾). Experts in the art will appreciate that this can be performed in many ways, from employing Shannon capacity, log2(1+SINR) to using the rate tables used by link adaptation schemes in cellular systems.

Initially, assume all users are on f1. Compute Tᵢ=Sᵢ⁽¹⁾/Sᵢ⁽²⁾ for i=1, 2, . . . , N and order them from lowest to highest values of Tᵢ. Begin with the user having the lowest value. Compute the effective rate that the user would receive on carrier 1 and carrier 2 by factoring in the user's spectral efficiency on each carrier and the expected bandwidth to be received. Without loss of generality, we assume that each user on a carrier will receive equal bandwidth and hence its expected bandwidth on carrier j=Wⱼ/Nⱼ, where Nⱼ is the number of users on carrier j assuming the given user is assigned to carrier j. Hence, the expected rate on carrier j for user i is

$${R}_{j} = {S}_{i}^{( j )} * \frac{{W}_{j}}{{N}_{j}}$$

and the user selects

argmax₁Rⱼ.

In another embodiment of this invention, different bandwidth allocations are allocated to users on a given carrier, and may be different for the same user across multiple carriers.

After a user is assigned to a carrier j, consider the user with the next lowest metric. Note that as more users are considered, the advantage in spectral efficiency of selecting the second carrier diminishes. Further, Nⱼ increases and the available resource must be shared with more users. At some point, users will receive a higher rate by remaining on the first carrier.

Simulation results have shown that this load balancing technique paired with power management can potentially provide up to a 3 times gain in edge and median user throughput over the baseline heterogeneous network scenario without this technique.

In order to highlight the crux of this approach, the embodiments described above deliberately assumed a rather simple scenario with a single class of users who get an equal share of the bandwidth associated with the carrier to which they are assigned. It is to be noted, however, that this approach is not limited to such scenarios. Those familiar with the art can apply this basic framework to more complex scenarios. The following is a brief description of some scenarios likely to be encountered in practice and how one might adapt some of the embodiments described above to those scenarios.
A. Restricted assignment based on class: Sometimes users are classified in accordance with their (current) mobility characteristics and/or the applications they are using, and users belonging to certain classes are allowed to be assigned to certain carriers only. For instance, in a heterogeneous network with soft reuse, highly mobile users and/or users engaged in certain real-time applications (e.g., voice calls) may be placed in a certain class that is allowed access only to the carrier that is transmitted at full power on macro cells. In such cases, users belonging to such restricted classes should be assigned to the corresponding carriers, and the impact of their assignment to these carriers should be computed before the “unrestricted” users are assigned to their carriers in accordance with the approach described above.
B. Bandwidth Reservation by User Class: On each carrier available at a cell, a certain amount of bandwidth may be reserved for each class of users. In this scenario, each class of users can be assigned independently to the carriers available to that class in accordance with the approach described above. While carrying out user assignment for a class, the bandwidth reserved for that class on a given carrier can be treated as the total bandwidth associated with that carrier.
C. Priorities: Users may be divided into multiple priority classes. The idea is that a user belonging to a higher priority class is typically a higher paying customer and expects better “user experience” than a lower paying customer. While priorities can be implemented in a number of ways, we describe a simple yet highly effective implementation of user priorities that offers a great deal of flexibility in providing differential treatment to different user classes.

In this implementation, there are K user classes such that if two users, one belonging to class m and the other to class n, are assigned to the same carrier on a cell, the share of the bandwidth they receive will be in the proportion kₘ: kₙ. The idea here is that if class m has a higher priority than class n, kₘ will be greater than kₙ so that class m users, in general, will be likely to receive preferential treatment compared to class n users. In this case, a simple tweak to the previously described approach is needed to carry out the assignment of users to carriers: Assume for simplicity that the cell carrying out user assignment has two carriers. As in the previously described approach, we begin by assuming that all users (indexed by i) are on carrier f1 and place them in an increasing order of Tᵢ=Sᵢ⁽¹⁾/Sᵢ⁽²⁾. In calculating Rⱼ(i), the rate a user, say i, receives on carrier j (j=1 or 2) when that carrier has Nj users assigned to it (including user i), we use the formula

$${R}_{j} ( i ) = {S}_{i}^{( j )} * {k}_{c ( i )} {W}_{j} / {\sum }_{u = 1}^{{N}_{j}} {k}_{c ( u ) }$$

instead of the one given above. In the present formula, c(u) denotes the class associated with user u. For a given user i, once the rate values Rⱼ(i) have been calculated for all carriers (namely, j=1 or 2 in the present example), it is assigned to the carrier that corresponds to the largest value of Rⱼ(i). That is, user i is assigned to the carrier jₘₐₓ₍ᵢ₎ where

$${j}_{max ( i )} = arg {max}_{j} {R}_{j} ( i ) .$$

Note that the approach in this case with multiple priority classes is essentially the same as before, except that the formula used for rate calculation has been modified to account for the fact that users belonging to different priority classes receive different shares of a carrier's bandwidth. Those familiar with the art can thus make similar modifications to the basic approach outlined above to account for the way priorities are implemented in a particular system.

The above examples illustrate how this basic approach can be applied to many of the scenarios one is likely to encounter in practice. Those familiar with the art can make similar modifications to suit the specific requirements of their implementation without violating the core concepts behind our approach. Also note that, although illustrated with two user classes, this approach is applicable to scenarios with more than two classes. In fact, extending it to the more general case is quite straightforward.

The detailed and, at times, very specific description above is provided to effectively enable a person of skill in the art to make, use, and best practice the present invention in view of what is already known in the art. In the examples, specifics are provided for the purpose of illustrating possible embodiments of the present invention and should not be interpreted as restricting or limiting the scope of the broader inventive concepts.

A person of skill in the art would readily recognize that steps of various above-described methods can be performed by programmed computers. Herein, some embodiments are intended to cover program storage devices, e.g., digital data storage media, which are machine or computer readable and encode machine-executable or computer-executable programs of instructions where said instructions perform some or all of the steps of methods described herein. The program storage devices may be, e.g., digital memories, magnetic storage media such as a magnetic disks or tapes, hard drives, or optically readable digital data storage media. The embodiments are also intended to cover computers programmed to perform said steps of methods described herein.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. Unless otherwise indicated herein, the use of relational terms, if any, such as first and second, top and bottom, and the like are used solely to distinguish one entity or action from another entity or action without necessarily requiring or implying any actual such relationship or order between such entities or actions.

The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

What is claimed is:

1. A method, comprising:
determining an achievable rate for a plurality of wireless devices on each carrier of a plurality of carriers;
performing inter-carrier load balancing by assigning a carrier of the plurality of carriers to each wireless device using the determined achievable rate of that wireless device on each carrier.

2. The method as recited in claim 1, wherein determining an achievable rate for the plurality of wireless devices on each carrier comprises
determining an achievable rate for the plurality of wireless devices on each carrier based at least in part on a channel quality for the plurality of wireless devices on each carrier of the plurality of carriers.

3. The method as recited in claim 2, wherein determining an achievable rate for the plurality of wireless devices on each carrier based at least in part on a channel quality for the plurality of wireless devices on each carrier comprises
receiving an indication of downlink signal quality for each carrier from each wireless device of the plurality of wireless devices.

4. The method as recited in claim 1, wherein determining an achievable rate for the plurality of wireless devices on each carrier comprises
determining an achievable rate for the plurality of wireless devices on each carrier based at least in part on a load on each carrier of the plurality of carriers.

5. The method as recited in claim 4 wherein the load on each carrier is based at least in part on a number of users on each carrier of the plurality of carriers.

6. The method as recited in claim 4 wherein the load on each carrier is based at least in part on an estimated traffic of users on each carrier of the plurality of carriers.

7. The method as recited in claim 1, wherein performing inter-carrier load balancing comprises
assigning, to the wireless device, the carrier on which the wireless device would achieve the highest determined achievable rate.

8. The method as recited in claim 1, further comprising
determining that a wireless device is a member of a restricted class;
assigning, to the wireless device prior to performing inter-carrier load balancing for the plurality of wireless devices, a carrier to which the restricted class is to be assigned.

9. The method as recited in claim 8, wherein determining that the wireless device is a member of a restricted class comprises
determining that the wireless device has a characteristic that includes at least one of a mobility characteristic or an application-use characteristic.

10. An article of manufacture comprising a processor-readable storage medium storing one or more software programs which when executed by one or more processors performs the steps of the method of claim 1.

11. Network equipment in a communication system, the network equipment being configured to communicate with other equipment in the system, wherein the network equipment is operative
to determine an achievable rate for a plurality of wireless devices on each carrier of a plurality of carriers, and
to perform inter-carrier load balancing by assigning a carrier of the plurality of carriers to each wireless device using the determined achievable rate of that wireless device on each carrier.

12. The network equipment of claim 11, wherein being operative to determine an achievable rate for the plurality of wireless devices on each carrier comprises
being operative to determine an achievable rate for the plurality of wireless devices on each carrier based at least in part on a channel quality for the plurality of wireless devices on each carrier of the plurality of carriers.

13. The network equipment of claim 12, wherein being operative to determine an achievable rate for the plurality of wireless devices on each carrier based at least in part on a channel quality for the plurality of wireless devices on each carrier comprises
being operative to receive an indication of downlink signal quality for each carrier from each wireless device of the plurality of wireless devices.

14. The network equipment of claim 11, wherein being operative to determine an achievable rate for the plurality of wireless devices on each carrier comprises
being operative to determine an achievable rate for the plurality of wireless devices on each carrier based at least in part on a load on each carrier of the plurality of carriers.

15. The network equipment of claim 14, wherein the load on each carrier is based at least in part on a number of users on each carrier of the plurality of carriers.

16. The network equipment of claim 14, wherein the load on each carrier is based at least in part on an estimated traffic of users on each carrier of the plurality of carriers.

17. The network equipment of claim 11, wherein being operative to perform inter-carrier load balancing comprises
being operative to assign, to the wireless device, the carrier on which the wireless device would achieve the highest determined achievable rate.

18. The network equipment of claim 11, being further operative
to determine that a wireless device is a member of a restricted class, and
to assign, to the wireless device prior to performing inter-carrier load balancing for the plurality of wireless devices, a carrier to which the restricted class is to be assigned.

19. The network equipment of claim 18, wherein being operative to determine that the wireless device is a member of a restricted class comprises
being operative to determine that the wireless device has a characteristic that includes at least one of a mobility characteristic or an application-use characteristic.

20. The network equipment of claim 11, wherein the network equipment comprises a base station.
